(19) United States
(12) Patent Application Publication
(10) Pub. No.: US 2005/0163430 A1
(43) Pub. Date: Jul. 28, 2005

(54) Distributing signal cross-connector for optical connectors

(75) Inventors: Ludovic Noirie, Nozay (FR); Denis Penninckx, Nozay (FR); Amaury Jourdan, Sevres (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL, Paris (FR)

(21) Appl. No.: 10/509,429

(22) PCT Filed: Mar. 25, 2003
(86) PCT No.: PCT/FR03/00867

(30) Foreign Application Priority Data
Mar. 25, 2002 (FR) 02/03694

(51) Int. Cl. G02B 6/38

(52) U.S. Cl. 385/56

(57) ABSTRACT

The present invention relates to a space cross-connect unit (Z) with N input ports (Eᵢ) and P output ports (Sᵢ) more particularly suitable for packet-switched optical communications networks. The cross-connect unit comprises a broadcast stage comprising at most N signal dividers (Aᵢ) each having an input and C outputs where C is an integer factor of P less than P, each input being connected to one of the N input ports (Eᵢ) so that each of the N dividers (Aᵢ) divides a signal received at one of the N input ports (Eᵢ) into C signals at the C outputs, and a space switching stage comprising at most C space switching modules (Bᵢ); each of the C modules (Bᵢ) has N inputs and P/C outputs, the N inputs are connected to N outputs of the broadcast stage, each of the N outputs comes from a different divider (Aᵢ), and each of the P/C outputs of the C modules (Bᵢ) is connected to a respective one of said P output ports (Sᵢ).

The present invention relates to a spatial broadcast signal cross-connect unit more particularly suitable for packet-switched optical communications networks.

An optical communications network consists of nodes. Each node receives signals from other nodes at its input ports and sends signals to other nodes from its output ports. Each signal received at an input port is therefore sent from an output port to another node intended to receive the signal. There must therefore be a correspondence relationship between the input signals received and the output signals sent. In other words the input signal received at a certain port must be properly directed to the correct output port. This is the function of a signal cross-connect unit. All of this is known in the art. Each cross-connect unit in each node directs each input signal to the associated output port.

It often proves beneficial for the same input signal to be broadcast to a plurality of output ports, i.e. to provide cross-connect units able to supply a plurality of output signals equivalent to any input signal. Cross-connect units of this kind are called broadcast cross-connect units.

Broadcast cross-connect units are described in the following papers:
“Design and implementation of a fully reconfigurable all-optical cross connect for high-capacity multi-wavelength transport network”, A. Jourdan et al., IEEE Journal of Lightwave Technology, Vol. 14, No.6, p. 1198, June 1996, and
“A 2.56 Tb/s throughput packet/cell-based optical switch fabric demonstrator”, S. Araki et al., ECOC'98, 20-24 September, Madrid, Spain.

Broadcast cross-connect units are able to supply an output signal equivalent to each input signal at each of the output ports of the node into whose input the signal was inserted.

However, broadcast cross-connect units broadcast a signal to all the output ports, which leads to serious loss of signal information since each signal is divided into a number of signals equal to the number of output ports.

Moreover, it is not necessary to send each signal to all the output ports when there is more than one port associated with the same destination node, which node therefore unnecessarily receives the same signal several times over.

Document EP 0.852.437 describes an optical space and time switching network which transfers input signals each having a defined wavelength to one or more output nodes without having to use a buffer memory if two input signals are to be sent to the same output node. The architecture disclosed in the above patent application comprises a divider-multiplexer stage comprising dividers and wavelength division multiplexers, a space switching stage comprising space switching matrices, and a wavelength selection stage comprising wavelength selectors. That kind of architecture transmits an input signal selectively to a plurality of output nodes rather than sending the input signal to all the output nodes.

However, the above architecture uses multiplexing to perform switching and presupposes the insertion of signals at different wavelengths at the input of each of the multiplexers. Inserting wavelength division multiplexed signals at the input implies a prior step of demultiplexing the signals.

Furthermore, recovering at the output signals having a defined wavelength imposes the use of wavelength selectors using optical gates.

The present invention aims to provide a space cross-connect unit with N input ports and P output ports comprising a broadcast stage and a switching stage to limit the broadcasting of an input signal to certain relevant output ports, thereby preventing loss of input signal information and enabling spatial broadcasting of input signals independently of any spectral considerations, i.e. without using multiplexing or wavelength selection.

To this end, the present invention proposes a space cross-connect unit with N input ports and P output ports, comprising:
a broadcast stage comprising at most N signal dividers each having one input and C outputs where C is an integer factor of P less than P, each input being connected to one of said N input ports so that each of said N dividers divides a signal received at one of said N input ports into C signals at said C outputs, and
a space switching stage comprising at most C space switching modules,
which cross-connect unit is characterized in that:
the C space switching modules are non-blocking and non-broadcasting, and
each of said C modules has N inputs and P/C outputs, said N inputs are connected to N outputs of said broadcast stage, each of said N outputs comes from a different divider, and each of said P/C outputs of said C modules is connected to a respective one of said P output ports.

By means of the invention, the division of the signal may be limited to the number C of relevant signals, known as the connectivity. This avoids the losses that would be caused by complete division of the signal, i.e. division into P signals.

Furthermore, the invention may be used with any type of input signals, each input signal being space switched to the output ports independently of any wavelength processing. Thus a multiplexed signal may also be sent to different output ports without it being necessary to process the wavelength of the signal, for example by demultiplexing the signal.

Moreover, the cross-connect unit does not use any multiplexing step between the broadcast stage and the switching stage.

One embodiment of the cross-connect unit comprises exactly N broadcasters and C space switching modules.

Each of said C modules advantageously comprises means for connecting each of its N inputs to a respective one of its P/C outputs.

In a first embodiment, each of the C switching modules is a non-blocking switching matrix with N inputs and P/C outputs.

In a second embodiment, each of the C switching modules comprises:
K non-blocking switching matrices with N/K inputs and P/C outputs, where K is an integer factor of N; and
P/C non-blocking switching matrices with K inputs and one output, each of said K inputs being connected to a respective output of each of said K switches.

This considerably reduces the size of the matrices compared to the previous embodiment, leading to a significant cost saving.

In one embodiment, at least one of the C switching modules comprises:
K non-blocking switching matrices with N/K inputs and P/C outputs, where K is an integer factor of N; and
P/C non-blocking switching matrices with K inputs and one output, each of said K inputs being connected to a respective output of each of said K switches.

The cross-connect unit may then be under-equipped, meaning that some switching modules comprise fewer than K switches or fewer than P/C switches. This limits the fabrication and installation cost, the omitted switches being added afterwards, as and when required.

In one variant, the number N of input ports may be equal to the number P of output ports.

In another variant, K is equal to C.

The switching stage advantageously uses a technology based on LiNbO₃. This technology produces non-broadcast switches, meaning that one input is connected to at most one output. Now, according to the invention, there is no benefit in using broadcast switches, broadcasting being effected at the level of the dividers. Thus LiNbO₃ technology lends itself very well to the invention.

The P/C switching matrices with K inputs and one output are advantageously semiconductor optical amplifier (SOA) switches.

Each of the P/C outputs of the C modules is advantageously followed by an amplifier. An amplifier restores input signal quality if the input signal suffers losses during division and switching, despite limited division of the signal at the input. For exactly the same reasons, each of the N inputs of the N dividers may be preceded by an amplifier.

In a preferred embodiment, each of said space switching modules comprises:
a first stage comprising polarization-maintaining space switching matrices; and
a second stage comprising polarization-maintaining semiconductor optical amplifiers.

The present invention also proposes a signal transmission system comprising a cross-connect unit according to the invention and characterized in that said system comprises:
at least one multiplexer for multiplexing M signals having M different wavelengths (λᵢ)_{1≦i≦M}, where M is an integer less than or equal to N;
at least one erbium-doped fiber amplifier (EDFA) for amplifying the multiplexed signal; and
at least one demultiplexer for demultiplexing the multiplexed signal to yield M demultiplexed signal that are input to M input ports of said cross-connect unit.

Thus the cross-connect unit of the invention may perfectly well use EDFA by sharing the amplifiers between a plurality of input ports judiciously grouping input signals having different wavelengths.

Other features and advantages of the present invention become apparent in the course of the following description of one embodiment of the invention, which is given by way of illustrative and non-limiting example.

In the drawings:

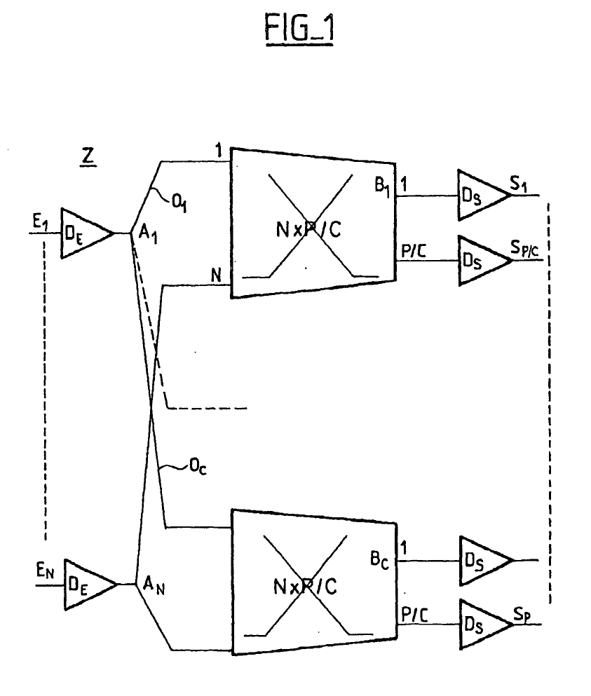

FIG. 1 represents the architecture of a first embodiment of a space cross-connect unit according to the invention,

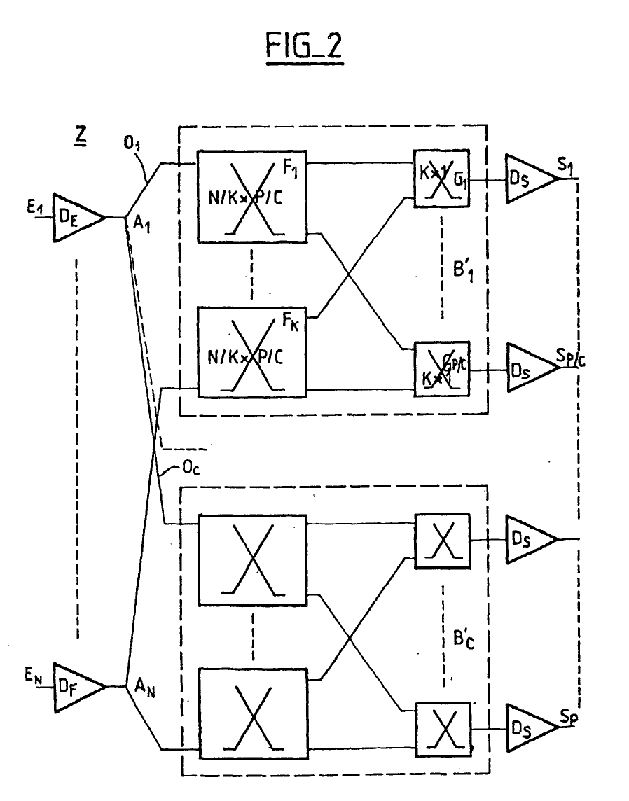

FIG. 2 represents the architecture of a second embodiment of a space cross-connect unit according to the invention,

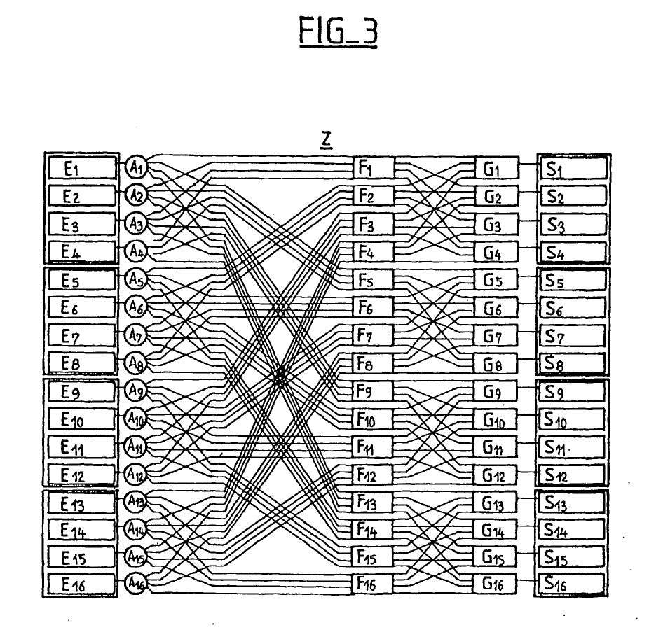

FIG. 3 represents a space cross-connect unit using the FIG. 2 architecture and having the same number of input and output ports, and

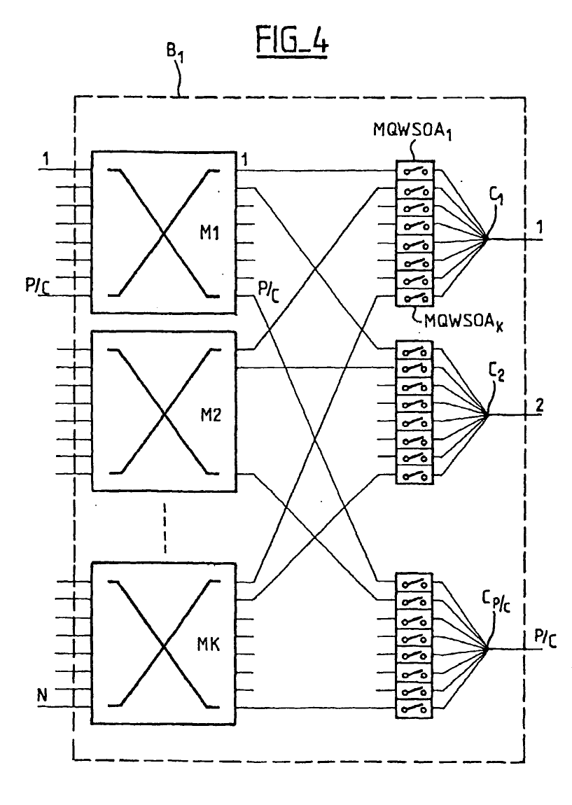

FIG. 4 represents one embodiment of a portion of a space cross-connect unit using the FIG. 1 architecture. Items carry the same reference number in all the figures.

FIG. 1 represents the architecture of a space cross-connect unit Z which has N input ports (Eᵢ)_{1>i≦S}, N couplers (Aᵢ)_{1≦i≦N}, N input amplifiers D_{E}, C switching matrices (Bᵢ)_{1≦i≦C}, P output amplifiers D_{S}, and P output ports (Sᵢ)_{1≦i≦P}.

The N input ports (Eᵢ)_{1≦i≦N} receive N input signals carrying information to be transmitted to the output.

The N couplers (Aᵢ)_{1≦i≦N} each have one input and are adapted to respond to each received input signal by broadcasting C signals carrying the same information as the input signal.

The C switching matrices (Bᵢ)_{1≦i≦C} are non-blocking space switches with N inputs and P/C outputs, C being a factor of P. Each of the C switches thus electrically connects each of its N inputs to a respective one of its P/C outputs.

An input signal is first amplified by one of the amplifiers D_{E}. The amplified input signal is injected into the input of one of the N couplers (Aᵢ)_{1≦i≦N} and is then broadcast to C respective outputs O₁, . . . , O_{c} of the coupler, thus producing C signals. Each of the C signals is injected into an input of each of the C switching matrices (Bᵢ)_{1≦i≦C}, which switches one of the C signals to one of its P/C outputs.

Each of the C switched signals is then amplified by one of the amplifiers D_{S}, which sends it to one of the output ports (Sᵢ)_{1≦i≦P}.

Thus C broadcast signals derived from the same input signal are obtained at the C output ports. Thus the cross-connect unit Z broadcasts a signal to C output ports, where C is less than P, in order to restrict the broadcasting of the input signal to the C relevant output ports, rather than to all of the P output ports.

The switching matrices may use technology based on LiNbO₃.

The amplifiers D_{E} and D_{S} are semiconductor optical amplifiers (SOA), for example.

Erbium-doped fiber amplifiers (EDFA), not shown, may equally be used for grouped amplification of M signals having M different wavelengths (λᵢ)_{1≦i≦M}, where M is an integer less than or equal to N, before the M signals are injected into the cross-connect unit. Thus the M signals are first grouped by a multiplexer, not shown. The multiplexed signal is amplified by an EDFA and the multiplexed and amplified signal is demultiplexed by a demultiplexer (not shown) to yield M signals, each of the M signals then entering one of the M input ports of the cross-connect unit.

FIG. 2 represents the architecture of a space cross-connect unit Z like that represented in FIG. 1 except that the C switching matrices (Bᵢ)_{1≦i≦C} are replaced by C switching modules (B′ᵢ)_{1≦i≦C}. Each of the C switching modules (B′ᵢ)_{1≦i≦C} comprises K non-blocking switching matrices (Fᵢ)_{1≦i≦K} with N/K inputs and P/C outputs, where K is an integer factor of N, and P/C non-blocking switching matrices (Gᵢ)_{1≦i≦P/C} with K inputs and one output.

Each of the K inputs of the P/C non-blocking switching matrices (Gᵢ)_{1≦i≦P/C} is connected to a respective output of each of the K non-blocking switching matrices (Fᵢ)_{1≦i≦K}.

The operation of the cross-connect unit is identical to that described with reference to FIG. 1.

For example, the non-blocking switching matrices (Gᵢ)_{1≦i≦P/C} are semiconductor optical amplifier (SOA) switches and the K non-blocking switching matrices (Fᵢ)_{1≦i≦K} are switches using technology based on LiNbO₃.

FIG. 3 represents a space cross-connect unit Z using the FIG. 2 architecture with 16 input ports and 16 output ports, where the integers K and C are equal to 4. The cross-connect unit Z has 16 inputs ports (Eᵢ)_{1≦i≦N}, 16 couplers (Aᵢ)_{1≦i≦N}, 16 non-blocking switching matrices (Fᵢ)_{1≦i≦K} with four inputs and four outputs, 16 non-blocking switching matrices (Gᵢ)_{1≦i≦P/C} with four inputs and one output, and 16 output ports (Sᵢ)_{1≦i≦P}. To clarify the diagram, the amplifiers are not shown.

A cross-connect unit may be incomplete, that is to say under-equipped. Thus, for reasons of fabrication and installation cost, installing fewer dividers than the maximum number N thereof or fewer switching modules than the maximum number C thereof may be envisaged. Similarly, a switching module may also be under-equipped; thus a switching module may comprise fewer than K non-blocking switching matrices with N/K inputs and P/C outputs or fewer than P/C non-blocking switching matrices with K inputs and one output. The components omitted are then added by the user as and when needed.

FIG. 4 shows one particular embodiment of the space switching modules B₁, . . . , B_{c} of a space cross-connect unit using the FIG. 1 architecture. For example, the module B₁ comprises:
a first stage consisting of K space switching matrices M₁, . . . , M_{K} (where K is an integer factor of N) having P/C inputs and P/C outputs, these inputs constituting the N inputs of the module B₁;
a second stage comprising P/C groups of amplifiers, such as the group MQWSOA₁, . . . , MQWSOA_{K}; these amplifiers are used as optical gates that are controlled by means that are not shown and each group has P/C inputs coupled to a respective output of each of the K matrices M₁, . . . , M_{K}; and
a third stage comprising P/C spectral multiplexers C₁ . . . , C_{P/C} each having K inputs connected to K respective outputs of the same group of amplifiers, such as the group MQWSOA₁, . . . , MQWSOA_{K}, the outputs of these multiplexers constituting the outputs of the module B₁.

In one advantageous embodiment, the matrices M₁, . . . , M_{K} are matrices exploiting the electro-optical properties of lithium niobate (LibNbO₃), such as Packet.8×8 matrices from Lynx (Israel), and the amplifiers MQWSOA₁, . . . , MQWSOA_{K} are multiple quantum well semiconductor optical amplifiers, which are available off the shelf.

Lithium niobate matrices offer very good performance but are highly sensitive to polarization. They are described as “polarization-maintaining” because they attenuate the optical signal if its plane of polarization does not coincide with a specific plane. To prevent such attenuation, it is therefore necessary to use polarization-maintaining optical components and optical connectors from the inputs E₁, . . . , E_{N} as far as the matrices M₁, . . . , M_{K}.

The multiple quantum well semiconductor optical amplifiers MQWSOA₁, . . . , MQWSOA_{K} offer better performance than semiconductor optical amplifiers that do not have multiple quantum wells, but they are highly sensitive to the polarization of the optical signals. Their use generally leads to an over-cost because it is necessary to use polarization-maintaining optical components and optical connectors on the upstream side of these amplifiers. However, in this embodiment of the cross-connect unit of the invention, they may be used without significant over-cost because the lithium niobate matrices M₁, . . . , M_{K} necessitate the use of polarization-maintaining optical components and optical connectors from the inputs E₁, . . . , E_{N} to the matrices M₁, . . . , M_{K} anyway.

Of course, the invention is not limited to the embodiments that have just been described. In particular, other technologies could be used for the switching matrices and the amplifiers.

Also, the cross-connect unit of the invention is equally suitable for packet switching and circuit switching.

Finally, any means may be replaced by equivalent means without departing from the scope of the invention.

1. A space cross-connect unit (Z) with N input ports (Eᵢ) and P output ports (Sᵢ), comprising:
a broadcast stage comprising at most N signal dividers (Aᵢ) each having one input and C outputs where C is an integer factor of P less than P, each input being connected to one of said N input ports (Eᵢ) so that each of said N dividers (Aᵢ) divides a signal received at one of said N input ports (Eᵢ) into C signals at said C outputs, and
a space switching stage comprising at most C space switching modules (Bᵢ, B′ᵢ),
which cross-connect unit is characterized in that:
the C space switching modules (Bᵢ, B′ᵢ) are non-blocking and non-broadcasting, and each of said C modules (Bᵢ, B′ᵢ) has N inputs and P/C outputs, said N inputs are connected to N outputs of said broadcast stage, each of said N outputs comes from a different divider (Aᵢ), and each of said P/C outputs of said C modules (Bᵢ, B′ᵢ) is connected to a respective one of said P output ports (Sᵢ).

2. A cross-connect unit (Z) according to claim 1, comprising exactly N dividers (Aᵢ) and C modules (Bᵢ, B′ᵢ).

3. A cross-connect unit (Z) according to claim 1, characterized in that each of said C modules (Bᵢ, B′ᵢ) comprises means for connecting each of its N inputs to one of its P/C outputs.

4. A cross-connect unit (Z) according to claim 1, characterized in that each of said C switching modules (Bᵢ, B′ᵢ) is a non-blocking switching matrix (Bᵢ) with N inputs and P/C outputs.

5. A cross-connect unit (Z) according to claim 1, characterized in that each of said C switching modules (B′ᵢ) comprises:
K non-blocking switching matrices (Fᵢ) with N/K inputs and P/C outputs, where K is an integer factor of N; and
P/C non-blocking switching matrices (Gᵢ) with K inputs and one output, each of said K inputs being connected to a respective output of each of said K switches (Fi).

6. A cross-connect unit (Z) according to claim 1, characterized in that at least one of said C switching modules (B′ᵢ) comprises:
K non-blocking switching matrices (Fᵢ) with N/K inputs and P/C outputs, where K is an integer factor of N; and
P/C non-blocking switching matrices (Gᵢ) with K inputs and one output, each of said K inputs being connected to a respective output of each of said K switches (Fᵢ).

7. A cross-connect unit (Z) according to claim 1, characterized in that said P/C switching matrices (Gᵢ) are semiconductor optical amplifier (SOA) switches.

8. A cross-connect unit (Z) according to claim 1, characterized in that said number N of input ports is equal to said number P of output ports.

9. A cross-connect unit (Z) according to claim 5, characterized in that K is equal to C.

10. A cross-connect unit (Z) according to claim 1, characterized in that said switching stage uses a technology based on LiNbO₃.

11. A cross-connect unit (Z) according to claim 1, characterized in that each of said P/C outputs of said C modules (Bᵢ, B′ᵢ) is followed by an amplifier (D_{S}).

12. A cross-connect unit according to claim 1, characterized in that each of said N inputs of said N dividers is preceded by an amplifier (D_{E}).

13. A cross-connect unit (Z) according to claim 1, characterized in that each of said space switching modules (Bᵢ, B′ᵢ) comprises:
a first stage comprising polarization-maintaining space switching matrices (M₁, . . . , M_{K}); and
a second stage comprising polarization-maintaining semiconductor optical amplifiers (MQWSOPA₁, . . . , MQWSOA_{K}).

14. A signal transmission system comprising a cross-connect unit (Z) according to claim 1 and characterized in that said system comprises:
at least one multiplexer for multiplexing M signals having M different wavelengths (λᵢ)_{1≦i≦M}, where M is an integer less than or equal to N;
at least one erbium-doped fiber amplifier (EDFA) for amplifying the multiplexed signal; and
at least one demultiplexer for demultiplexing the multiplexed signal to yield M demultiplexed signal that are input to M input ports of said cross-connect unit.
